(19) United States
(12) Patent Application Publication
(10) Pub. No.: US 2026/0260310 A1
(43) Pub. Date: Sep. 3, 2026

(54) HARDWARE SUPPORT FOR PLANAR INPUT AND OUTPUT

(71) Applicant: QUALCOMM Incorporated, San Diego, CA (US)

(72) Inventors: Nilanjan GOSWAMI, Livermore, CA (US); Brian ELLIS, San Diego, CA (US); Tao WANG, Sunnyvale, CA (US); Marshia Angeline SETO, San Diego, CA (US); Dam BACKER, San Diego, CA (US); Philip MARSHALL, San Diego, CA (US)

(21) Appl. No.: 19/069,013

(22) Filed: Mar. 3, 2025

(51) Int. Cl. G06T 1/20; G06T 1/60

(52) U.S. Cl. CPC G06T 1/20; G06T 1/60

(57) ABSTRACT

Aspects presented herein relate to methods and devices for data or graphics processing including an apparatus, e.g., a GPU. The apparatus may obtain an indication of interleaved data for the data processing, where the interleaved data corresponds to data in an interleaved format. The apparatus may also perform, during a processing of the interleaved data, a conversion of a layout for the interleaved data to a layout for planar data, where the planar data corresponds to the data in a planar format. Further, the apparatus may output an indication of the conversion of the layout for the interleaved data to the layout for the planar data.

### TECHNICAL FIELD

The present disclosure relates generally to processing systems and, more particularly, to one or more techniques for data or graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may execute a number of different instructions in a graphics processing pipeline. However, there has developed a need for improved instruction execution in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a component at a graphics processor, a controller, a render backend (RB), a shader processor, a central processing unit (CPU), or any apparatus that may perform for graphics processing. The apparatus may obtain an indication of interleaved data for the data processing, where the interleaved data corresponds to data in an interleaved format. The apparatus may also configure at least one component to perform the conversion of the layout for the interleaved data to the layout for the planar data. The apparatus may also initiate the processing of the interleaved data prior to the performance of the conversion of the layout for the interleaved data to the layout for the planar data. Additionally, the apparatus may write data for the layout for the interleaved data prior to the performance the conversion of the layout for the interleaved data to the layout for planar data. The apparatus may also perform, during a processing of the interleaved data, a conversion of a layout for the interleaved data to a layout for planar data, where the planar data corresponds to the data in a planar format. The apparatus may also compress at least one of the interleaved data or the planar data after the performance of the conversion of the layout for the interleaved data to the layout for the planar data. Moreover, the apparatus may output an indication of the conversion of the layout for the interleaved data to the layout for the planar data.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 includes diagrams illustrating an example GPU in accordance with one or more techniques of this disclosure.

FIG. 8 is a diagram illustrating an example conversion process in accordance with one or more techniques of this disclosure.

FIG. 9 is a diagram illustrating an example planar output generation process in accordance with one or more techniques of this disclosure.

FIG. 10 is a diagram illustrating an example conversion process in accordance with one or more techniques of this disclosure.

FIG. 11 is a diagram illustrating an example conversion process in accordance with one or more techniques of this disclosure.

FIG. 12 is a diagram illustrating an example conversion process in accordance with one or more techniques of this disclosure.

FIG. 13 is a communication flow diagram illustrating example communications between a GPU, an application/GPU, and a memory in accordance with one or more techniques of this disclosure.

FIG. 14 is a flowchart of an example method of data processing in accordance with one or more techniques of this disclosure.

FIG. 15 is a flowchart of an example method of data processing in accordance with one or more techniques of this disclosure.

### DETAILED DESCRIPTION

As indicated herein, GPUs may need to support field sequential displays (FSDs), which may need GPU-generated vector content (e.g., red (R), green (G), blue (B) (RGB) alpha (A) (RGBA) content) to be converted into a planar format. FSD displays may be important for certain display products (e.g., augmented reality (AR) or virtual reality (VR) products), and achieving certain types of conversion (e.g., interleaved-to-planar surface conversion) efficiently may be important for maintaining high performance and low power consumption. The conversion from RGBA to planar formats can introduce additional processing overhead, which can negatively impact the performance and power efficiency of GPUs. High performance GPUs with ultra-low power profiles may be needed to support certain devices (e.g., next generation AR/VR devices), which may need efficient handling of these types of conversion to avoid performance degradation and increased power consumption. However, certain types of solutions (e.g., software-based solutions) for planar output generation may result in subpar performance and added power overhead. Based on the above, it may be beneficial to provide an interleaved-to-planar surface conversion (e.g., an RGB-to-planar surface conversion or RGBA-to-planar surface conversion) that optimizes power consumption.

Aspects of the present disclosure may include a number of benefits or advantages. For instance, aspects of the present disclosure may optimize or improve an interleaved-to-planar surface conversion process. That is, aspects presented herein may provide an interleaved-to-planar surface conversion (e.g., an RGB-to-planar surface conversion or RGBA-to-planar surface conversion) that optimizes power consumption (e.g., power consumption at a GPU). For instance, aspects presented herein may provide a hardware-based solution for interleaved-to-planar surface conversion that can generate a planar output. Indeed, aspects presented herein may provide a hardware-based solution for interleaved-to-planar surface conversion that can generate a planar output with minimal or no additional performance and power costs compared to other output generations (e.g., RGBA output generation). Aspects presented herein may also allow a GPU to write the output of an interleaved-to-planar surface conversion to a planar format. For example, aspects presented herein may allow certain components in a GPU (e.g., a render backend (RB), a cache and compression unit (CCU), or a shader processor) to write the output to planar formant. By doing so, aspects presented herein may allow a GPU to optimize the amount of power utilized for this process. Indeed, by utilizing certain components in a GPU (e.g., RB, CCU, or a shader processor) to write the output to a planar formant, aspects presented herein may save GPU power as these GPU components may already be writing certain outputs to memory. This is beneficial because there is no additional memory traffic utilized at a GPU during this process. That is, aspects presented herein may avoid wasting any additional memory cycles at a GPU. In turn, this may optimize or improve the overall performance of a GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

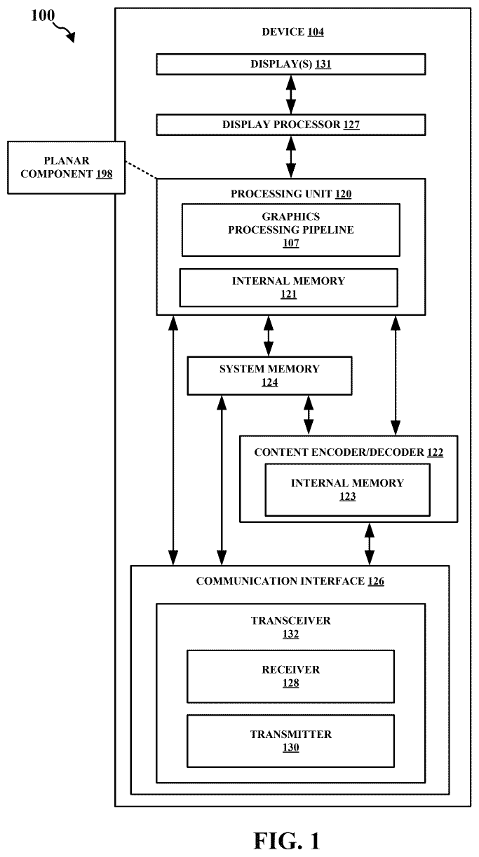

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a planar component 198 configured to obtain an indication of interleaved data for the data processing, where the interleaved data corresponds to data in an interleaved format. The planar component 198 may also be configured to configure at least one component to perform the conversion of the layout for the interleaved data to the layout for the planar data. The planar component 198 may also be configured to initiate the processing of the interleaved data prior to the performance of the conversion of the layout for the interleaved data to the layout for the planar data. The planar component 198 may also be configured to write data for the layout for the interleaved data prior to the performance the conversion of the layout for the interleaved data to the layout for planar data. The planar component 198 may also be configured to perform, during a processing of the interleaved data, a conversion of a layout for the interleaved data to a layout for planar data, where the planar data corresponds to the data in a planar format. The planar component 198 may also be configured to compress at least one of the interleaved data or the planar data after the performance of the conversion of the layout for the interleaved data to the layout for the planar data. The planar component 198 may also be configured to output an indication of the conversion of the layout for the interleaved data to the layout for the planar data. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

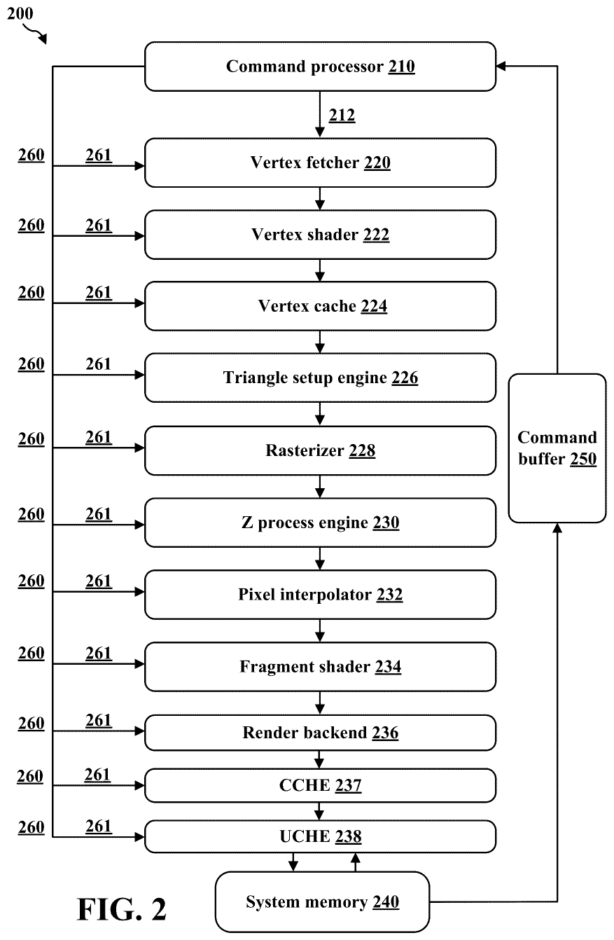

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, a unified level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

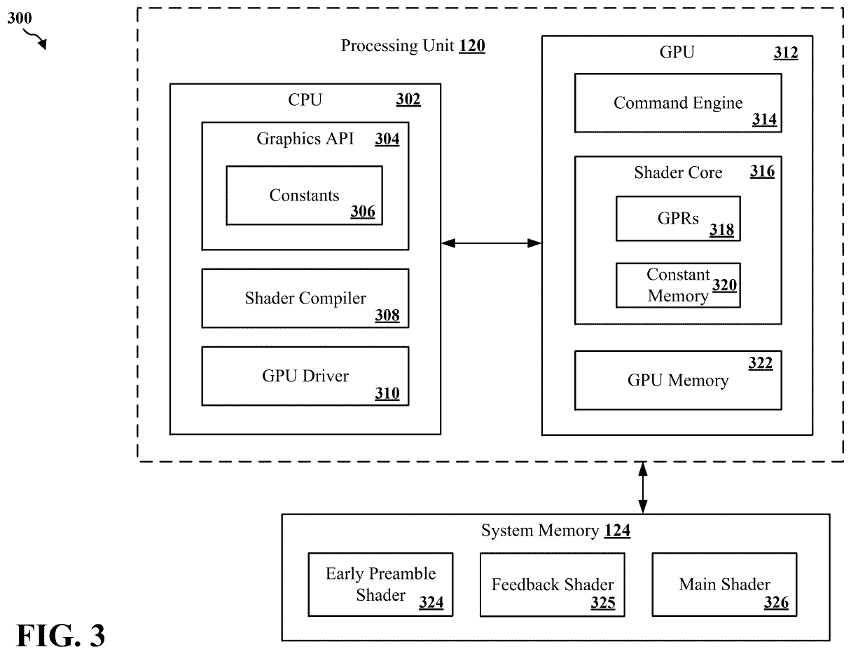

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

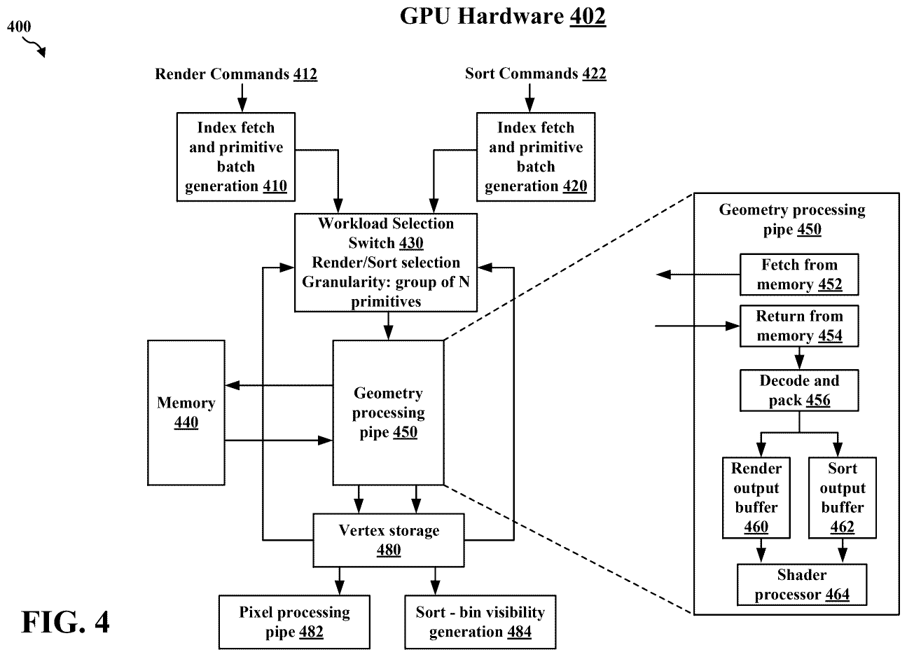

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 480, pixel processing pipe 482, and sort-bin visibility generation component 484. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 480, which may be sent to pixel processing pipe 482 and sort-bin visibility generation component 484.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

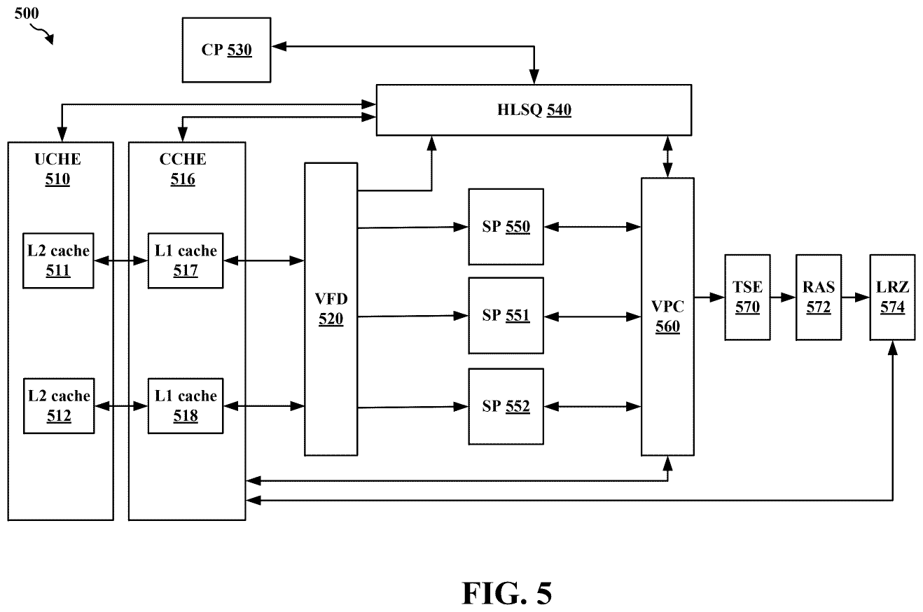

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of shader processors (e.g., shader processor 550, shader processor 551, and shader processor 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to shader processors 550-552. Moreover, shader processors 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

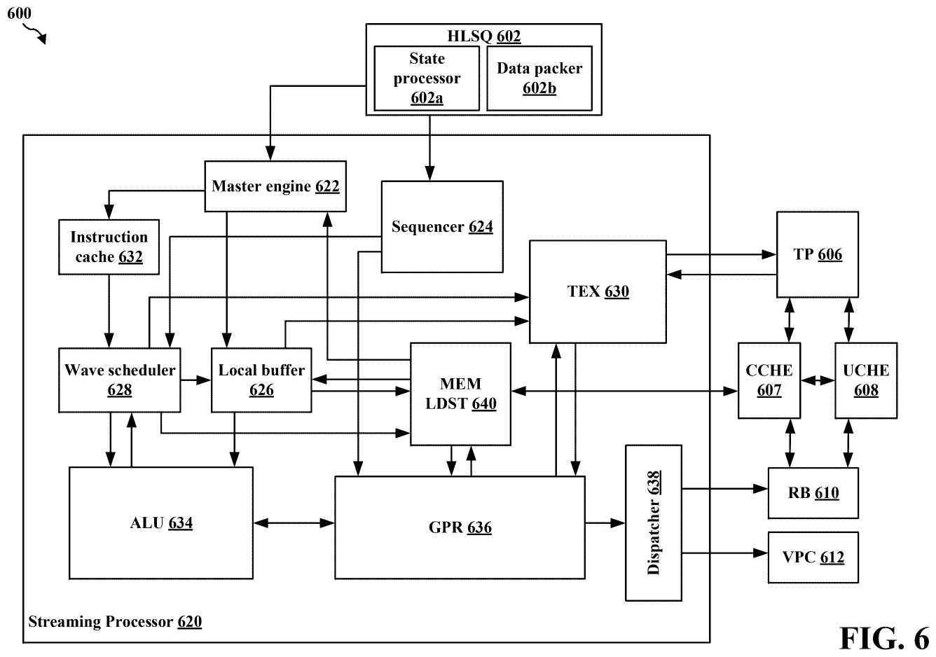

FIG. 6 illustrates an example GPU 600. Specifically, FIG. 6 illustrates a streaming processor or shader processor system in GPU 600. As shown in FIG. 6, GPU 600 includes a high level sequencer (HLSQ) 602, texture processor (TP) 606, level 1 (L 1) cache (cluster cache (CCHE)) 607, level 2 (L 2) cache (UCHE) 608, render backend (RB) 610, and vertex cache (VPC) 612. GPU 600 also includes streaming processor 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640. In some aspects, streaming processor 620 may be referred to as a shader processor.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the streaming processor 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the streaming processor 620. For example, the HLSQ 602 may prepare the context states for different types of data, e.g., global register data, shader constant data, buffer descriptors, instructions, etc. Additionally, the HLSQ 602 may embed context states into a command stream to the streaming processor 620. The master engine 622 may parse the command stream from the HLSQ 602 and setup a streaming processor global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the streaming processor 620 may not be limited to executing a preamble if the HLSQ 602 decides to skip a preamble execution. For instance, the streaming processor 620 may also process a conventional graphics workload, such as vertex shading and/or fragment shading. In some aspects, the streaming processor 620 may utilize its execution units and storage in order to process compute tasks as a general purpose GPU (GPGPU). Inside the streaming processor 620, there may be multiple parallel instruction execution units such as an ALU, elementary function unit (EFU), branching unit, TEX, general memory read and write (aka LDST), etc. The streaming processor 620 may also include on-chip storage memory, such as a GPR 636 which may store per-fiber private data. Also, the streaming processor 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in a streaming processor context register may be utilized to define the GPR identifier (ID) which stores RT data.

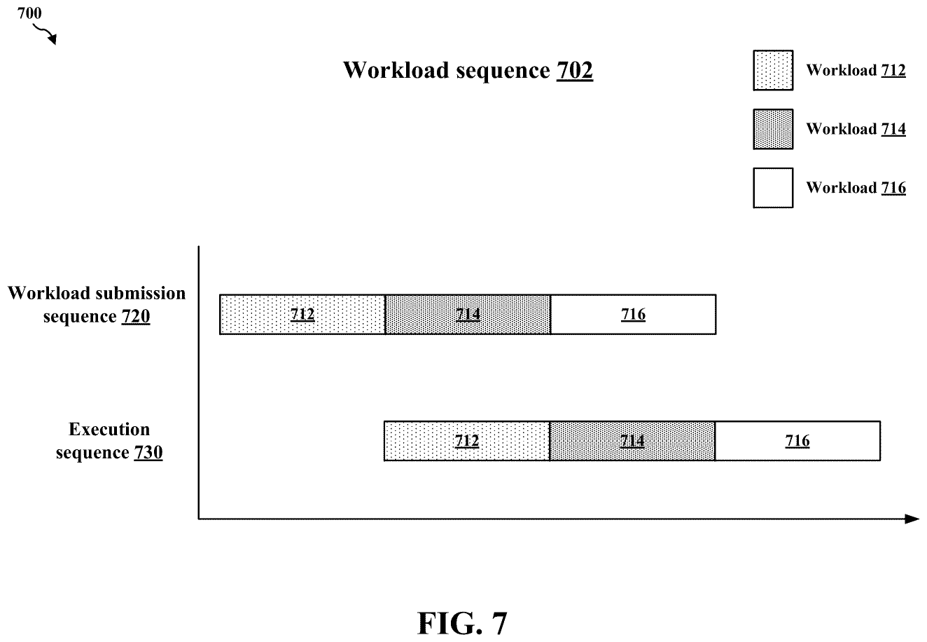

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. This type of scenario is shown in FIG. 7.

FIG. 7 illustrates diagram 700 including one example of a workload execution sequence. More specifically, diagram 700 depicts a workload execution sequence for a GPU (i.e., a scheduled execution order). As shown in FIG. 7, diagram 700 includes workload sequence 702 including workload 712, workload 714, workload 716, workload submission sequence 720, and execution sequence 730. FIG. 7 depicts a timeline of workload execution including workload submission sequence 720 and execution sequence 730. FIG. 7 illustrates that certain types of workloads (e.g., workload 712, workload 714, and workload 716) are executed in a certain order as per the scheduled workload sequence. As shown in FIG. 7, consider a workload submission sequence 720 to be workload 712, workload 714, and workload 716. Each of these workload may need to fetch data from memory and send it to shader processor for further processing. In some aspects, there may be a limit on how many requests can be made without processing the returned data (e.g., an OT limit). In some instances, some of the memory accesses for workload 714 may be granted before all accesses for workload 712, and some of the memory accesses for workload 716 may be granted before all accesses for workload 714.

In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

Some types of GPUs may include a number of different types of registers or memory, such as general purpose registers (GPRs). A GPR may be a register that stores both data and addresses. That is, the GPR may be a combined data/address register. In some architectures, a register file may be unified so that a GPR may store certain types of numbers (e.g., floating-point numbers). A register may refer to a location that may be accessed by a processor. Additionally, a register may include a small amount of relatively quickly accessible storage. GPUs may include other types of memory, such as graphics memory (GMEM) or on-chip memory, which may store data or data buffers.

Modern GPUs may include a number of different types of GPRs, such as vector GPRs and scalar GPRs. Vector GPRs are fiber based GPRs, which are costly to GPU performance and memory (e.g., each fiber may have its own GPR). As indicated above, the term wave may refer to a set of threads or blocks that run concurrently on a GPU, where waves may include a number of fibers for executing instructions at the GPU. Vector GPRs may also limit a parallel wave number at a GPU. Scalar GPRs may be shared by all fibers in a wave, which may be cheaper to build/access, as well as more power efficient, than vector GPRs. For example, in a vector GPR, 1 wave of 64 fibers may correspond to 64 physical instances of the vector GPR using the GPU hardware. In a scalar GPR, there may be one GPR inside of the GPU hardware. That is, a GPU may include scalar GPRs and vector GPRs, where scalar GPRs may be more efficient than vector GPRs.

In graphics processing and computer graphics, a shader may be a computer program that calculates a level of light (e.g., light, darkness, and color) during the rendering of a scene. This process of rendering and shading a scene may be referred to as shading. Shaders may perform a variety of specialized functions in graphics processing, computer graphics, video post-processing, and general-purpose computing on graphics processors. A shader may be a program that is used to control the rendering effects of computer graphics. There may be a number of different types of shaders (e.g., vertex shaders, pixel shaders, and geometry shaders), which may handle a different aspect of the rendering process. Shaders may be used to produce lighting, shadows, textures, and other visual effects in video games, simulations, and other applications. A shader processor may utilize context states to perform various operations and calculations. That is, a shader processor may be part of multiple shared cores for integer processing. Additionally, a shader processor may execute shader code (e.g., vertex shaders, fragment shaders, compute shaders, etc.).

As indicated herein, in bin or tiled rendering, there may be different types of memory storage, e.g., system or SoC memory and GMEM or on-chip memory, to store different data or information, e.g., the color or depth for a particular tile. In some aspects, the rendering data for each tile or bin may be transferred during an unresolve or resolve process. During the unresolve process, data or information may be moved from the system memory to the GMEM. Likewise, during the resolve process, data or information may be moved from the GMEM to the system memory. This process may then be repeated for the next bin or tile. In some aspects, GMEM or on-chip memory may have a limited data size. Accordingly, the process of transferring rendered information from the GMEM to the system memory or frame buffer may be performed on a tile-by-tile basis. For example, the GMEM may have a size to store colors of 256×256 pixels, which may correspond to the size of a tile. A frame buffer or system memory may have a larger data size compared to the size of the GMEM, e.g., may store colors of 1920×1080 pixels. In some aspects, when partitioning a frame buffer, e.g., 1920×1080 pixels, this may be performed in multiple steps based on the size of each tile, e.g., 256×256 pixels.

As mentioned above, when storing or writing data or information to the system memory or frame buffer, a tile or bin may be unresolved when moving data or information from the system memory to the GMEM. Also, a tile or bin may be resolved when moving data or information from the GMEM to the system memory. For example, the resolving process may transfer data or information the size of a tile, e.g., 256×256 pixels, to the system memory. GPUs may then move to another tile and continue the unresolve/resolve process, such as by unresolving the tile from the system memory to GMEM, rendering the tile, and then resolving the tile from the GMEM to the system memory. This process may continue until the entire frame buffer is filled. As indicated herein, data for each tile may be moved from the system memory to the GMEM, i.e., the unresolve process, and then after rendering the data may be moved from the GMEM back to the system memory, i.e., the resolve process. Thus, the unresolve process may be an inverse movement of data compared to the resolve process. This unresolve/resolve process may be performed because the GPU memory or GMEM may be able to store less information compared to the system memory. So once rendered, tile data may be moved from the GMEM back to the frame buffer and stored on the system memory. As such, the rendered data for a tile may be transferred to the frame buffer on the system memory. Also, in some aspects, during the unresolve process, data stored at the frame buffer may be transferred to the GMEM when it is needed to render a tile at the GPU. Accordingly, a portion of the frame buffer data may be transferred from the system memory to the GMEM, and after rendering based on this data, the data may be transferred back to the frame buffer at the system memory. This process may be performed for each bin or tile until the entire surface is finished rendering.

Additionally, in some aspects, each tile may be rendered multiple rendering times, such that a portion of a tile is rendered. Accordingly, rendering data may be transferred multiple times back and forth between the system memory and the GMEM during the unresolve/resolve process. For example, GPUs may render one aspect of a surface or tile, e.g., a background, and this data may be stored at the system memory while other aspects of the surface or tile are rendered. This data may then be transferred back to the GPU when rendering another part of a scene, e.g., a character. This process may also be referred to as rendering in multiple paths. Further, GPUs may render different aspects of a scene at different times. For example, the diffuse color of a scene may be rendered, then the spectral color, and then the shadows. So a frame buffer may store data incrementally when the tile or bin is rendered in multiple paths. Also, during the process of rendering each bin or tile, data may be transferred back and forth between the system memory and the GPU memory multiple times.

In certain types of GPUS (e.g., bin rendering GPUs), switching back to a previous rendered surface may involve a number of different operations for each bin. For example, certain data, e.g., color and depth data, for a bin may be moved from a buffer, e.g., a color and depth buffer in the system memory, to GPU internal memory for color and depth. As mentioned above, this process may be referred to as an unresolve process. The bin or tile may then be rendered based on the data, e.g., color and depth data. The data, e.g., color and depth data, may then be moved from GPU internal memory for color and depth to a buffer, e.g., color and depth buffer, in the system memory. As mentioned above, this process may be referred to as a resolve process. In some instances, when unresolving a tile or bin, the entire tile may be transferred from the system memory to the GMEM prior to rendering the tile. After rendering, the entire tile may be resolved from the GMEM to the system memory. So when transferring certain data for a tile in order to render the tile, e.g., to and/or from the system memory and the GMEM, the data for the entire tile may be transferred. As indicated herein, it may take both GPU power and performance in order to transfer data from the system memory to the GMEM, and vice versa, for the unresolve and resolve processes.

Some aspects of color processing may utilize a color space, which is a specific organization of colors. For instance, a color space may support reproducible representations of color, such as whether such representation entails an analog or a digital representation. For example, a red (R), green (G), blue (B) (RGB) color space may be a category of additive colorimetric color spaces that specify part of its absolute color space definition using the RGB color model. RGB color spaces are commonly found describing the mapping of the RGB color model to human perceivable color, but some RGB color spaces may use imaginary (non-real-world) primaries and may not be displayed directly. Red (R), green (G), blue (B), alpha (A) (RGBA) may be described as a color space or a three-channel RGB color model supplemented with a fourth alpha (A) channel. Alpha indicates the opacity of each pixel and allows an image to be combined over others using alpha compositing, with transparent areas and anti-aliasing of the edges of opaque regions. A color space conversion may correspond to the translation of a representation of a color from one basis to another. This may occur in the context of converting an image that is represented in one color space to another color space. Normally, the goal of color space conversion is to make the translated image look as similar as possible to the original image. A color space converter (CSC) may be a device that changes signal(s) from one color space to another. CSCs may translate how a color is represented from one basis to another, as the goal of CSCs may be to make the converted image look as similar as possible to the original. CSCs may be used to make images compatible with display devices or to prepare them for transmission or compression. CSCs are used in many image and video display systems, including televisions, computer monitors, color printers, video telephony, and surveillance systems.

One type of color conversion is an interleaved-to-planar surface conversion (e.g., an RGB-to-planar surface conversion or RGBA-to-planar surface conversion). Normally, in memory, the RGB pixels may be listed in order (e.g., RGB, RGB, RGB, etc.). But an interleaved-to-planar surface conversion may reorder the pixels from an interleaved layout (e.g., RGB, RGB, RGB, RGB) to a non-interleaved layout (e.g., RRR, GGG, BBB or RRR, GGG, BBB, AAA). This interleaved-to-planar surface conversion is an addressing problem including bytes, so there are interleaved bytes (e.g., RGB or RGBA followed by RGB or RGBA), and the conversion is trying to update to non-interleaved bytes. Field sequential display (FSDs) might be able to produce a performance and power optimized high quality display content if supplied with an interleaved-to-planar surface converted (e.g., an RGB-to-planar surface conversion) frame buffer data (in planar format). Indeed, for a viable product, system designers may desire the display results of RGB-to-planar surface conversions to be performed on a system before sending the frame buffer to FSDs. However, FSDs may need further processing pass for GPU generated vector content (e.g., RGBA content) to be converted to planar content. For instance, high performance and high power GPUs with may be used for this type of content when utilizing augmented reality (AR) or virtual reality (VR). For example, dual/single architecture GPUs may be used in design and workload analysis for this type of interleaved-to-planar surface conversion. Also, any additional processing overhead in any local GPUs may reduce the performance and increase the power consumption. That is, a render GPU may help with content rendering and a system GPU may help with composition.

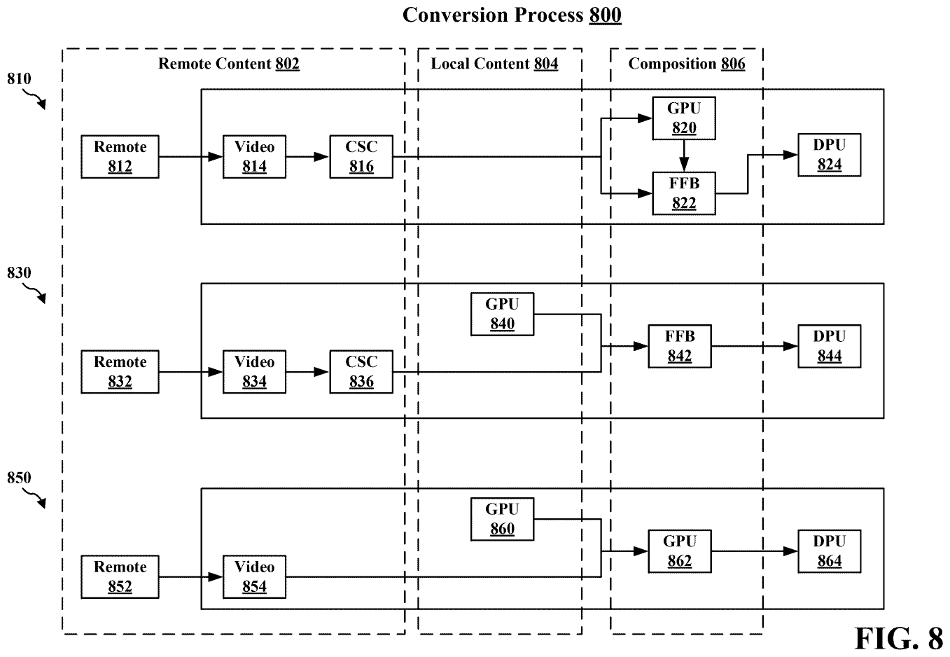

FIG. 8 illustrates diagrams including example diagrams for a conversion process. More specifically, diagram 810, diagram 830, and diagram 850 depicts an example conversion process 800 for a GPU. Diagram 810 includes remote content 802, local content 804, composition 806, remote component 812, video component 814, color space converter (CSC) 816, GPU 820, fixed function block (FFB) 822 (e.g., a hardened compositor), and DPU 824. As shown in FIG. 8, diagram 810 shows one type of interleaved-to-planar surface conversion process, where remote content 802 includes remote component 812, video component 814, and CSC 816, local content 804 does not include any component, and composition 806 includes GPU 820, FFB 822, and DPU 824. Diagram 830 includes remote content 802, local content 804, composition 806, remote component 832, video component 834, color space converter (CSC) 836, GPU 840, fixed function block (FFB) 842 (e.g., a hardened compositor), and DPU 844. Also, diagram 830 shows another type of interleaved-to-planar surface conversion process, where remote content 802 includes remote component 832, video component 834, and CSC 836, local content 804 includes GPU 840, and composition 806 includes GPU 862, FFB 842, and DPU 844. Diagram 850 includes remote content 802, local content 804, composition 806, remote component 852, video component 854, GPU 860, GPU 862, and DPU 864. Further, diagram 850 shows another type of interleaved-to-planar surface conversion process, where remote content 802 includes remote component 852 and video component 854, local content 804 includes GPU 860, and composition 806 includes GPU 862 and DPU 864.

Additionally, users that desire using FSD displays as a viable display solution for interleaved-to-planar surface conversion may utilize certain product categories. In some instances, low use case content may be low power (e.g., less than a threshold amount of power) for system-on-chips (SoCs). Also, the content may be displayed at a certain rate (e.g., a 10 Hz rate) with a certain fill rate (e.g., less than 10% fill rate). Average use case content may be displayed at a certain rate (e.g., 120 Hz) with a certain fill rate (e.g., 20-35% fill-rate). Also, high use case content may be displayed at a certain rate (e.g., 120 Hz display rate) with a certain fill rate (e.g., 100% fill rate). Additionally, software-based solutions may include the uncertainty of subpar performance with added power overhead. However, unlike software-based solutions, a GPU hardware-based native solution may be able to generate planar output at a limited to no additional performance/power cost compared to other output generations (e.g., an RGBA output generation).

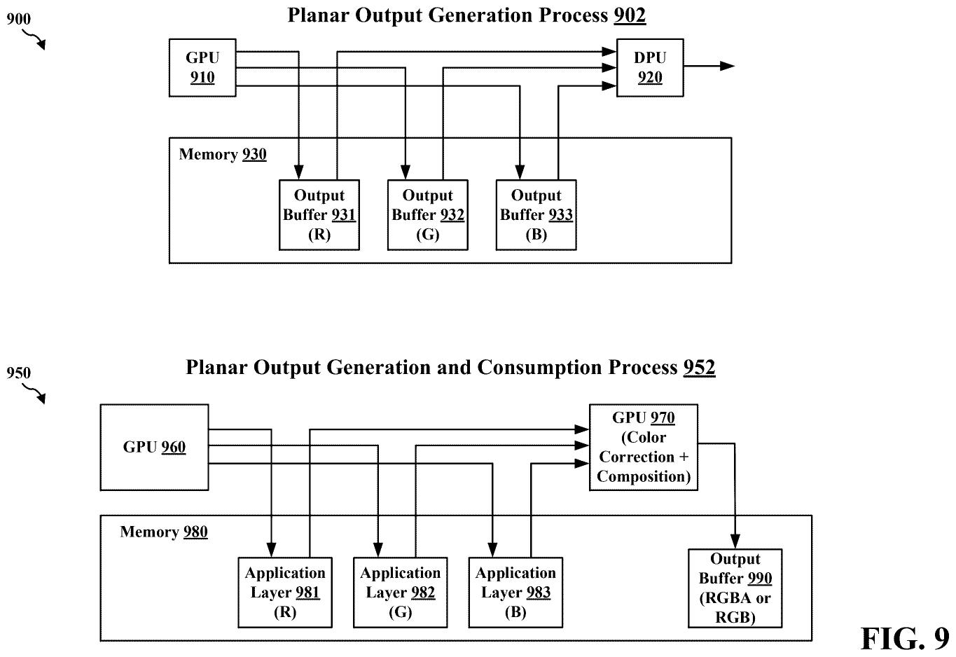

FIG. 9 illustrates diagrams including one example of a planar output generation process. More specifically, diagram 900 depicts an example planar output generation process 902 and diagram 950 depicts an example planar output generation and consumption process 952. Diagram 900 includes GPU 910, DPU 920, memory 930 including output buffer 931 (e.g., a red (R) buffer), output buffer 932 (e.g., a green (G) buffer), and output buffer 933 (e.g., a blue (b) buffer). As depicted in diagram 900, planar output generation process 902 includes when hardware (e.g., GPU 910) outputs the planar content for FSD displays to be processed by DPU 920. In some aspects, planar output generation process 902 may be software/client visible, and also an invasive and time-consuming effort. Planar output generation process 902 may also include tentative usage scenario, and be comparatively less pervasive. Diagram 950 includes GPU 960, GPU 970 (e.g., geometry, color correction techniques, and compensation), memory 980 including application layer 981 (e.g., a red (R) application layer), application layer 982 (e.g., a green (G) application layer), application layer 983 (e.g., a blue (B) application layer), and output buffer 990 (e.g., an RGBA or RGB output buffer). As depicted in diagram 950, planar output generation and consumption process 952 includes a multi-GPU system that can use planar content to perform operations (i.e., GPU-based post-processing, etc.). Further, data may be kept on a cache to avoid any data access trips to a DRAM. As depicted in FIG. 9, current planar output generation and consumption processes may need additional hardware blocks to be updated. Also, these type of planar output generation and consumption processes may be more invasive and need additional efforts to be viable.

As indicated herein, GPUs may need to support field sequential displays (FSDs), which may need GPU-generated vector content (e.g., RGBA content) to be converted into a planar format. FSD displays may be important for certain display products (e.g., AR/VR products), and achieving certain types of conversion (e.g., interleaved-to-planar surface conversion) efficiently may be important for maintaining high performance and low power consumption. The conversion from RGBA to planar formats can introduce additional processing overhead, which can negatively impact the performance and power efficiency of GPUs. High performance GPUs with ultra-low power profiles may be needed to support certain devices (e.g., next generation AR/VR devices), which may need efficient handling of these types of conversion to avoid performance degradation and increased power consumption. However, certain types of solutions (e.g., software-based solutions) for planar output generation may result in subpar performance and added power overhead. Based on the above, it may be beneficial to provide an interleaved-to-planar surface conversion (e.g., an RGB-to-planar surface conversion or RGBA-to-planar surface conversion) that optimizes performance and power consumption. Also, it may be beneficial to provide a hardware-based solution for interleaved-to-planar surface conversion that can generate a planar output. That is, it may be beneficial to provide a hardware-based solution for interleaved-to-planar surface conversion that can generate a planar output with minimal or no additional performance and power costs compared to other output generations.

Aspects of the present disclosure may optimize or improve an interleaved-to-planar surface conversion process. That is, aspects presented herein may provide an interleaved-to-planar surface conversion (e.g., an RGB-to-planar surface conversion or RGBA-to-planar surface conversion) that optimizes power consumption (e.g., power consumption at a GPU). For instance, aspects presented herein may provide a hardware-based solution for interleaved-to-planar surface conversion that can generate a planar output. Indeed, aspects presented herein may provide a hardware-based solution for interleaved-to-planar surface conversion that can generate a planar output with minimal or no additional performance and power costs compared to other output generations (e.g., RGBA output generation). Aspects presented herein may also allow a GPU to write the output of an interleaved-to-planar surface conversion to a planar format. For example, aspects presented herein may allow certain components in a GPU (e.g., a render backend (RB), a cache and compression unit (CCU), or a shader processor) to write the output to planar formant. By doing so, aspects presented herein may allow a GPU to optimize the amount of power utilized for this process. Indeed, by utilizing certain components in a GPU (e.g., RB, CCU, or a shader processor) to write the output to a planar formant, aspects presented herein may save GPU power as these GPU components may already be writing certain outputs to memory. This is beneficial because there is no additional memory traffic utilized at a GPU during this process. That is, aspects presented herein may avoid wasting any additional memory cycles at a GPU. In turn, this may optimize or improve the overall performance of a GPU.

Aspects presented herein may utilize a GPU component-based solution to save GPU power in order to write certain outputs to memory. For example, aspects presented herein may utilize updates at a RB, CCU, or a shader processor at a GPU to write certain outputs to memory. Aspects presented herein may support certain types of rendering (e.g., direct mode rendering and binned mode rendering) at a GPU. Additionally, aspects presented herein may merge requests (e.g., read requests and write requests) for color data into single coalesced accesses, thus optimizing performance for larger primitives (e.g., triangles). The approach of aspects herein may support planar data storage in caches or dynamic random access memory (DRAM), thus reducing the performance impact compared to certain data access (e.g., vectorized RGBA data access). Aspects presented herein may also modify a resolve engine to update memory at a GPU (e.g., a DRAM) with planar data during a resolve operation, while supporting binned mode rendering. During a resolve process, data or information may be moved from a GMEM to a system memory. Aspects presented herein may minimize latency and maintain performance by keeping vectorized data in on-chip graphics memory. Also, aspects herein address performance issues related to small primitive (e.g., triangle) rendering, which can be problematic in some implementations. The proposed hardware-based solutions described herein offer a more efficient and low-power alternative to software-based methods for generating planar outputs. Aspects presented herein may be important for supporting the performance and power conditions of certain display-based devices (e.g., next generation AR/VR devices), thus making them highly suitable for users.

Aspects presented herein (e.g., a GPU) may obtain an indication of interleaved data for the data processing, where the interleaved data corresponds to data in an interleaved format. Aspects presented herein (e.g., a GPU) may also configure at least one component to perform the conversion of the layout for the interleaved data to the layout for the planar data. Further, aspects presented herein (e.g., a GPU) may initiate the processing of the interleaved data prior to the performance of the conversion of the layout for the interleaved data to the layout for the planar data. Additionally, aspects presented herein (e.g., a GPU) may write data for the layout for the interleaved data prior to the performance the conversion of the layout for the interleaved data to the layout for planar data. Aspects presented herein (e.g., a GPU) may also perform, during a processing of the interleaved data, a conversion of a layout for the interleaved data to a layout for planar data, where the planar data corresponds to the data in a planar format. Aspects presented herein (e.g., a GPU) may also compress at least one of the interleaved data or the planar data after the performance of the conversion of the layout for the interleaved data to the layout for the planar data. Moreover, aspects presented herein (e.g., a GPU) may output an indication of the conversion of the layout for the interleaved data to the layout for the planar data.

Aspects presented herein may utilize different ways in which to generate a planar output for an interleaved-to-planar surface conversion process. In one example, aspects presented herein may update certain components at a GPU (e.g., a RB or a CCU). In this example, direct mode rendering and binned mode rendering may be supported. If this example works, there may be a single solution. In one example, aspects presented herein may modify a controller for a compression or decompression engine at a GPU. In this example, binned mode rendering may be supported, but there may be no support for direct rendering. Additionally, in another example, on-chip graphics memory (e.g., a color cache) to internal cache data may be converted from RGBA to planar format. In this example, just direct mode rendering may be supported.

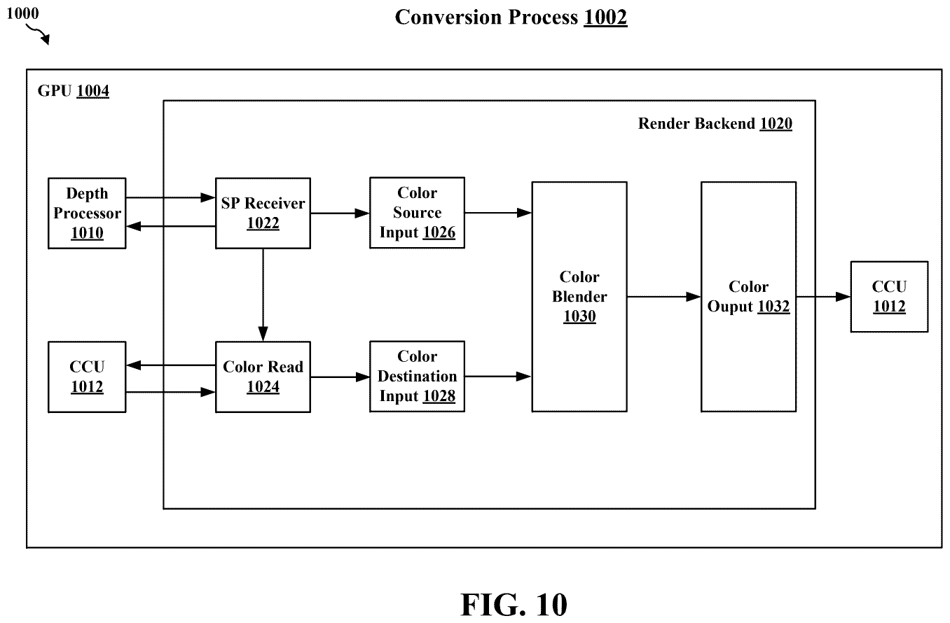

FIG. 10 illustrates diagrams including one example of a conversion process. More specifically, diagram 1000 depicts an example conversion process 1002 for a GPU 1004. Diagram 1000 includes GPU 1004 including depth processor 1010, cache and compression unit (CCU) 1012, and render backend (RB) 1020. RB 1020 includes shader processor (SP) receiver 1022, color read component 1024, color source input 1026, color destination input 1028, color blender 1030, and color output 1032. As shown in FIG. 10, depth processor 1010 may send information to SP receiver 1022, and CCU 1012 may send information to color read component 1024. SP receiver 1022 may send information to depth processor 1010, color read component 1024, and color source input 1026. Color read component 1024 may send information to CCU 1012 and color destination input 1028. Both color source input 1026 and color destination input 1028 may send information to color blender 1030. Color blender 1030 may send information to color output 1032, which may send information to CCU 1012. As depicted in FIG. 10, aspects presented herein may update certain GPU components (e.g., update RB 1020 or CCU 1012) to generate a planar output for an interleaved-to-planar surface conversion process.

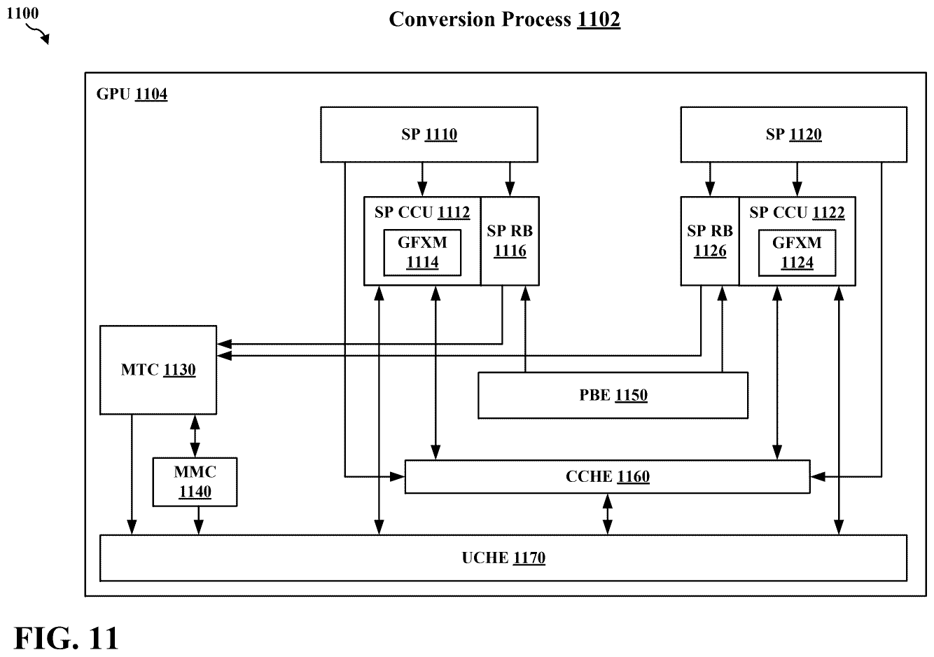

FIG. 11 illustrates diagrams including one example of a conversion process. More specifically, diagram 1100 depicts an example conversion process 1102 for a GPU 1104. Diagram 1100 includes GPU 1104 including shader processor (SP) 1110, SP CCU 1112, graphics memory (GFXM) 1114, SP RB 1116, SP 1120, SP CCU 1122, GFXM 1124, SP RB 1126, memory traffic compression (MTC) unit 1130, MTC meta cache (MMC) component 1140, parallel blending engine (PBE) 1150, level 1 (L1) cache or cluster cache (CCHE) 1160, and unified level cache (UCHE) 1170. As shown in FIG. 11, SP 1110 may send information to SP CCU 1112, GFXM 1114, SP RB 1116, and CCHE 1160. SP 1120 may send information to SP CCU 1122, GFXM 1124, SP RB 1126, and CCHE 1160. Both SP CCU 1112 and GFXM 1114 may send information to CCHE 1160 and UCHE 1170. Also, both SP CCU 1122 and GFXM 1124 may send information to CCHE 1160 and UCHE 1170. SP RB 1116 and SP RB 1126 may send information to MTC unit 1130. Further, MTC unit 1130 may send information to MMC component 1140 and UCHE 1170. MMC component 1140 may send information to MTC unit 1130 and UCHE 1170. PBE 1150 may send information to SP RB 1116 and SP RB 1126. Also, CCHE 1160 may send information to SP CCU 1112, GFXM 1114, SP CCU 1122, GFXM 1124, and UCHE 1170. UCHE 1170 may send information to SP CCU 1112, GFXM 1114, SP CCU 1122, GFXM 1124, and CCHE 1160.

As depicted in FIG. 11, read requests for color data or write requests for color data may be processed together. That is, read requests for color data or write requests for color data may be processed together if those requests belong to the same primitive. For example, as shown in FIG. 11, SP 1110 may supply data to SP CCU 1112 and SP RB 1116 (e.g., data for 16 primitives), where SP CCU 1112 and SP RB 1116 include a certain throughput (e.g., a throughput of 16 primitives). Also, SP 1120 may supply data to SP CCU 1122 and SP RB 1126 (e.g., data for 16 primitives), where SP CCU 1122 and SP RB 1126 include a certain throughput (e.g., a throughput of 16 primitives). For aspects presented herein, the SP and RB throughput may need to be increased (e.g., increased by 2×). As shown in FIG. 11, for a large enough primitive this should not be a problem. If primitive size is smaller than a certain size (e.g., 16×16 pixels), this may be expected to have lower performance than certain types of data access (e.g., vectorized RGBA color data access). For future composition scenarios, this may be a smaller for a certain size (e.g., 16×16 pixels) for better warping and for addressing various display issues (e.g., AR or VR). Aspects presented herein may be able to support both direct mode rendering and binned mode rendering, as planar data either may reside on different types of memory or caches (e.g., DRAM or GMEM).

Aspects presented herein may also utilize a resolve engine update at a GPU to generate a planar output for an interleaved-to-planar surface conversion process. For example, aspects presented herein may update the resolve engine (e.g., a parallel blending engine (PBE)) to update DRAM with planar data during a resolve operation. By doing so, the GFXM may keep the vectorized data and current rendering pipelines may remain unaffected. This may be able to run on binned rendering mode, but binned mode may be a better alternative if a primitive count exceeds a limit when the performance benefits of direct rendering mode are non-existent. Also, the parallel blending engine (e.g., PBE)-based change may address any small primitive-related performance issues. This approach may have no additional latency overhead. In some instances of the aforementioned parallel blending engine approach, just the resolve operation may be optimized, as the unresolve operation may be supported but may not be optimized. Also, a GFXM bin to system memory (SYSMEM) write path may be optimized. A special control register bit in the CRE may indicate if the RGBA-to-planar conversion may be performed for color blocks. That is, there may be software level control for enabling this in the CRE. Additionally, the CCU/PBE compression path may need extra storage (e.g., 1024B×2(double buffer) storage) for additional channels (e.g., three additional channels). For example, 1024B intermediate storage for RGBA tile for MTC or 1024B×2×2 intermediate storage for planar UBWC tile (e.g., 1024B for each R/G/B/A channel). This may result in even more additional storage. The PBE may compress each tile and update off-chip memory with each MTC tile and MMC with metadata.

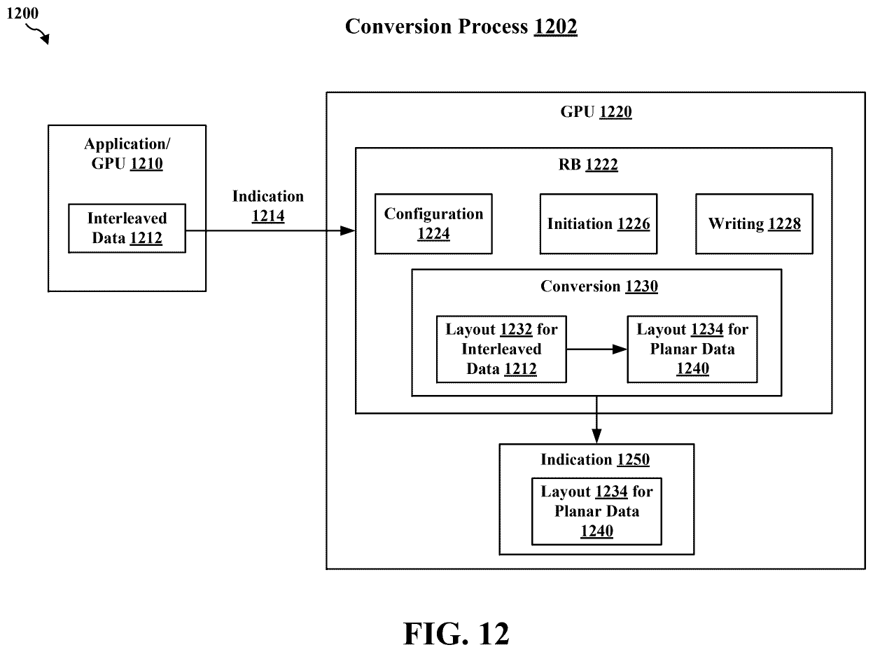

FIG. 12 illustrates diagram 1200 including an example conversion process. More specifically, diagram 1200 depicts one example of a conversion process 1202 within a GPU 1220. As shown in FIG. 12, diagram 1200 includes application/GPU 1210, interleaved data 1212, indication 1214, GPU 1220, render backend (RB) 1222, configuration component 1224, initiation component 1226, writing component 1228, conversion 1230, layout 1232 for interleaved data 1212, layout 1234 for planar data 1240, and indication 1250. As shown in FIG. 12, GPU 1220 may obtain indication 1214 of interleaved data 1212 for data processing, where the interleaved data corresponds to data in an interleaved format. GPU 1220 (e.g., RB 1222) may configure (via configuration component 1224) at least one component to perform the conversion of a layout for the interleaved data 1212 to the layout for planar data 1240. GPU 1220 (e.g., RB 1222) may also initiate (via initiation component 1226) the processing of the interleaved data 1212 prior to the performance of the conversion of the layout for the interleaved data to the layout for the planar data 1240. GPU 1220 (e.g., RB 1222) may also write data (via writing component 1228) for the layout for the interleaved data 1212 prior to the performance the conversion of the layout for the interleaved data to the layout for planar data 1240. GPU 1220 (e.g., RB 1222) may also perform, during a processing of the interleaved data, a conversion 1230 of a layout 1232 for the interleaved data 1212 to a layout 1234 for planar data 1240, where the planar data 1240 corresponds to the data in a planar format. GPU 1220 (e.g., RB 1222) may also compress at least one of the interleaved data 1212 or the planar data 1240 after the performance of the conversion 1230 of a layout 1232 for the interleaved data 1212 to a layout 1234 for planar data 1240. Moreover, GPU 1220 (e.g., RB 1222) may output an indication 1250 of the conversion 1230 of a layout 1232 for the interleaved data 1212 to a layout 1234 for planar data 1240.

As indicated herein, low-power displays and specific customer products may need a solution that can natively support planar output from the GPU. Aspects herein may provide GPU based composition solutions be more performance and power efficient. Application specific integrated circuit (ASIC) based composition pipes may also be able to use the planar data for more efficient composition for FSD type displays. Based on the render mode (e.g., direct, binned, etc.) and customer implementation strategies (e.g., composition grid size, processing stages), the GPU pipeline can harden to output the planar data natively. Compared to other software-based solutions and generic bandwidth compression modification based solutions, the GPU hardware level planar output generation support of aspects herein may be the most performance/power efficient.

Aspects of the present disclosure may include a number of benefits or advantages. For instance, aspects of the present disclosure may optimize or improve an interleaved-to-planar surface conversion process. That is, aspects presented herein may provide an interleaved-to-planar surface conversion (e.g., an RGB-to-planar surface conversion or RGBA-to-planar surface conversion) that optimizes power consumption (e.g., power consumption at a GPU). For instance, aspects presented herein may provide a hardware-based solution for interleaved-to-planar surface conversion that can generate a planar output. Indeed, aspects presented herein may provide a hardware-based solution for interleaved-to-planar surface conversion that can generate a planar output with minimal or no additional performance and power costs compared to other output generations (e.g., RGBA output generation). Aspects presented herein may also allow a GPU to write the output of an interleaved-to-planar surface conversion to a planar format. For example, aspects presented herein may allow certain components in a GPU (e.g., a render backend (RB), a cache and compression unit (CCU), or a shader processor) to write the output to planar formant. By doing so, aspects presented herein may allow a GPU to optimize the amount of power utilized for this process. Indeed, by utilizing certain components in a GPU (e.g., RB, CCU, or a shader processor) to write the output to a planar formant, aspects presented herein may save GPU power as these GPU components may already be writing certain outputs to memory. This is beneficial because there is no additional memory traffic utilized at a GPU during this process. That is, aspects presented herein may avoid wasting any additional memory cycles at a GPU. In turn, this may optimize or improve the overall performance of a GPU.

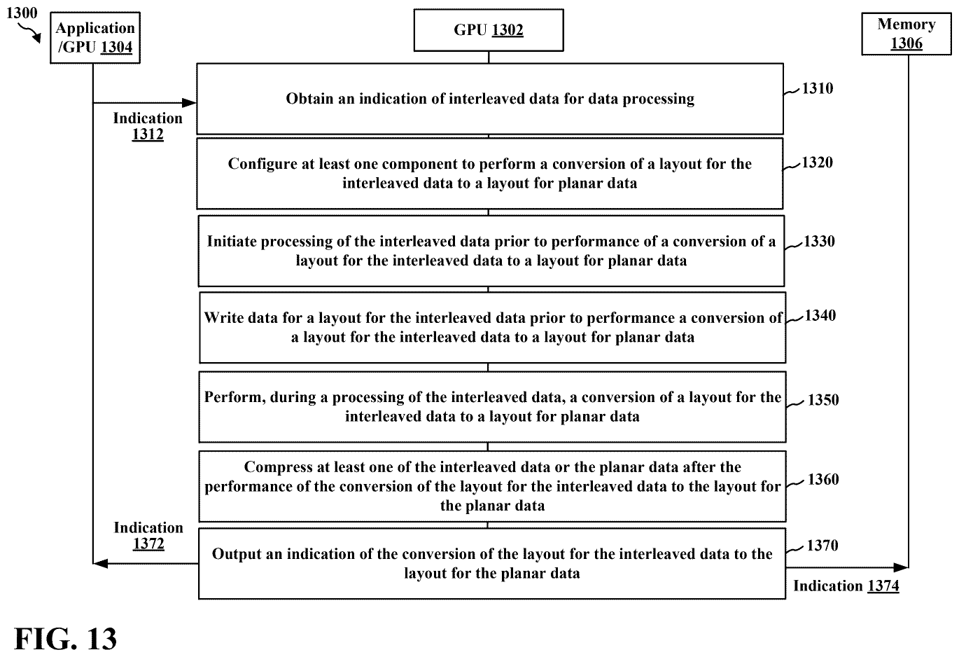

FIG. 13 is a communication flow diagram 1300 of data processing in accordance with one or more techniques of this disclosure. As shown in FIG. 13, diagram 1300 includes example communications between GPU 1302 (e.g., a GPU, a graphics pipeline at a GPU, a shader processor at a GPU, a render backend (RB) in a GPU, a GPU component, another graphics processor, a CPU, a CPU component, or another central processor), application/GPU 1304 (e.g., an application, a GPU, a graphics pipeline at a GPU, a shader processor at a GPU, a render backend (RB) in a GPU, a GPU component, another graphics processor, a CPU, a CPU component, or another central processor), and memory 1306 (e.g., a memory, a cache, a system memory, a graphics memory, a memory or cache at a CPU, or a memory or cache at a GPU), in accordance with one or more techniques of this disclosure.

At 1310, GPU 1302 may obtain an indication of interleaved data for the data processing, where the interleaved data corresponds to data in an interleaved format. For example, GPU 1302 may obtain indication 1312 from application/GPU 1304.

At 1320, GPU 1302 may configure at least one component to perform the conversion of the layout for the interleaved data to the layout for the planar data. In some aspects, the at least one component may be at least one graphics component in a graphics processing unit (GPU). Also, the at least one component in the GPU may be at least one of: a render backend (RB), a cache interfacing unit, or a controller for a compression engine or a decompression engine.

At 1330, GPU 1302 may initiate the processing of the interleaved data prior to the performance of the conversion of the layout for the interleaved data to the layout for the planar data. In some aspects, performing the conversion of the layout for the interleaved data to the layout for the planar data may comprise: performing, during at least one stage of the processing of the interleaved data, the conversion of the layout for the interleaved data to the layout for the planar data.

At 1340, GPU 1302 may write data for the layout for the interleaved data prior to the performance the conversion of the layout for the interleaved data to the layout for planar data. In some aspects, performing the conversion of the layout for the interleaved data to the layout for the planar data comprises: performing, based on writing the data, the conversion of the layout for the interleaved data to the layout for the planar data. Writing the data for the layout for the interleaved data may comprise: writing, to at least one of a color cache or a color memory, the data for the layout for the interleaved data, where the data in at least one of the color cache or the color memory is the planar data. Also, writing the data for the layout for the interleaved data may comprise: writing, to an interleaved color memory, the data for the layout for the interleaved data, where the data in the interleaved color memory is the interleaved data. Further, writing the data for the layout for the interleaved data may comprise: writing, to an interleaved color cache, the data for the layout for the interleaved data, where the data in the interleaved color cache is the interleaved data.

At 1350, GPU 1302 may perform, during a processing of the interleaved data, a conversion of a layout for the interleaved data to a layout for planar data, where the planar data corresponds to the data in a planar format. The layout for the interleaved data may be a memory layout for the interleaved data and the layout for the planar data may be a memory layout for the planar data. In some aspects, performing the conversion of the layout for the interleaved data to the layout for the planar data may comprise: organizing the memory layout for the interleaved data for the conversion to the memory layout for the planar data. Also, organizing the memory layout for the interleaved data may comprise: adjusting a block of interleaved pixels for the memory layout for the interleaved data. Further, adjusting the block of the interleaved pixels for the memory layout for the interleaved data may comprise: grouping at least one component of the block of the interleaved pixels to obtain at least one plane for an output for the planar data. Moreover, grouping the at least one component of the block of the interleaved pixels to obtain the at least one plane for the output for the planar data may comprise: grouping a first component and a second component of the block of the interleaved pixels to obtain a first plane and a second plane for the output for the planar data. The at least one component of the block of the interleaved pixels may be a set of four components of the block of the interleaved pixels, and the at least one plane for the output for the planar data may be a set of four planes for the output for the planar data.

At 1360, GPU 1302 may compress at least one of the interleaved data or the planar data after the performance of the conversion of the layout for the interleaved data to the layout for the planar data. In some aspects, compressing at least one of the interleaved data or the planar data may comprise: compressing, at an end of the processing of the interleaved data, at least one of the interleaved data or the planar data. The interleaved data may be data that includes a set of first pixel components that is a first threshold distance within one component of a pixel from the data, and the planar data may be data that includes a set of second pixel components that is a second threshold distance within one plane from the data. Additionally, the interleaved data may be at least one of: interleaved color data, interleaved pixel data, interleaved compute data, or interleaved graphics attributes, and the planar data may be at least one of: planar color data, planar pixel data, planar compute data, or planar graphics attributes.

At 1370, GPU 1302 may output an indication of the conversion of the layout for the interleaved data to the layout for the planar data. In some aspects, outputting the indication of the conversion of the layout for the interleaved data to the layout for the planar data may comprise: transmitting the indication of the conversion of the layout for the interleaved data to the layout for the planar data. For example, GPU 1302 may transmit indication 1372 to application/GPU 1304. Further, outputting the indication of the conversion of the layout for the interleaved data to the layout for the planar data may comprise: storing, in a tile memory or a graphics memory, the indication of the conversion of the layout for the interleaved data to the layout for the planar data. For example, GPU 1302 may store indication 1374 in memory 1306.

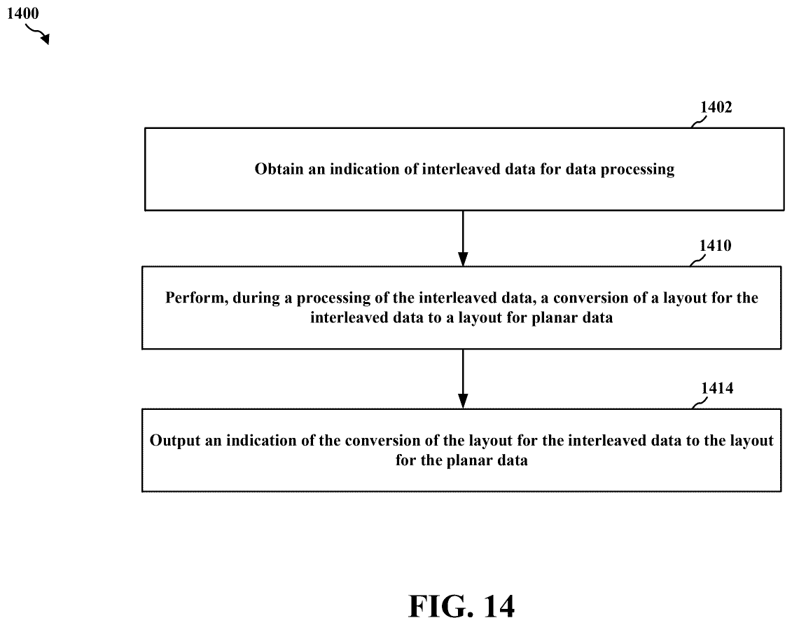

FIG. 14 is a flowchart 1400 of an example method of data processing in accordance with one or more techniques of this disclosure. The method may be performed by a GPU (e.g., a GPU, a graphics pipeline at a GPU, a shader processor at a GPU, a render backend (RB) in a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-13.

At 1402, the GPU may obtain an indication of interleaved data for the data processing, where the interleaved data corresponds to data in an interleaved format, as described in connection with the examples in FIGS. 1-13. For example, as described in 1310 of FIG. 13, GPU 1302 may obtain an indication of interleaved data for the data processing, where the interleaved data corresponds to data in an interleaved format. Further, step 1402 may be performed by processing unit 120 in FIG. 1. For example, GPU 1302 may obtain indication 1312 from application/GPU 1304.

At 1410, the GPU may perform, during a processing of the interleaved data, a conversion of a layout for the interleaved data to a layout for planar data, where the planar data corresponds to the data in a planar format, as described in connection with the examples in FIGS. 1-13. For example, as described in 1350 of FIG. 13, GPU 1302 may perform, during a processing of the interleaved data, a conversion of a layout for the interleaved data to a layout for planar data, where the planar data corresponds to the data in a planar format. Further, step 1410 may be performed by processing unit 120 in FIG. 1. The layout for the interleaved data may be a memory layout for the interleaved data and the layout for the planar data may be a memory layout for the planar data. In some aspects, performing the conversion of the layout for the interleaved data to the layout for the planar data may comprise: organizing the memory layout for the interleaved data for the conversion to the memory layout for the planar data. Also, organizing the memory layout for the interleaved data may comprise: adjusting a block of interleaved pixels for the memory layout for the interleaved data. Further, adjusting the block of the interleaved pixels for the memory layout for the interleaved data may comprise: grouping at least one component of the block of the interleaved pixels to obtain at least one plane for an output for the planar data. Moreover, grouping the at least one component of the block of the interleaved pixels to obtain the at least one plane for the output for the planar data may comprise: grouping a first component and a second component of the block of the interleaved pixels to obtain a first plane and a second plane for the output for the planar data. The at least one component of the block of the interleaved pixels may be a set of four components of the block of the interleaved pixels, and the at least one plane for the output for the planar data may be a set of four planes for the output for the planar data.

At 1414, the GPU may output an indication of the conversion of the layout for the interleaved data to the layout for the planar data, as described in connection with the examples in FIGS. 1-13. For example, as described in 1370 of FIG. 13, GPU 1302 may output an indication of the conversion of the layout for the interleaved data to the layout for the planar data. Further, step 1414 may be performed by processing unit 120 in FIG. 1. In some aspects, outputting the indication of the conversion of the layout for the interleaved data to the layout for the planar data may comprise: transmitting the indication of the conversion of the layout for the interleaved data to the layout for the planar data. For example, GPU 1302 may transmit indication 1372 to application/GPU 1304. Further, outputting the indication of the conversion of the layout for the interleaved data to the layout for the planar data may comprise: storing, in a tile memory or a graphics memory, the indication of the conversion of the layout for the interleaved data to the layout for the planar data. For example, GPU 1302 may store indication 1374 in memory 1306.

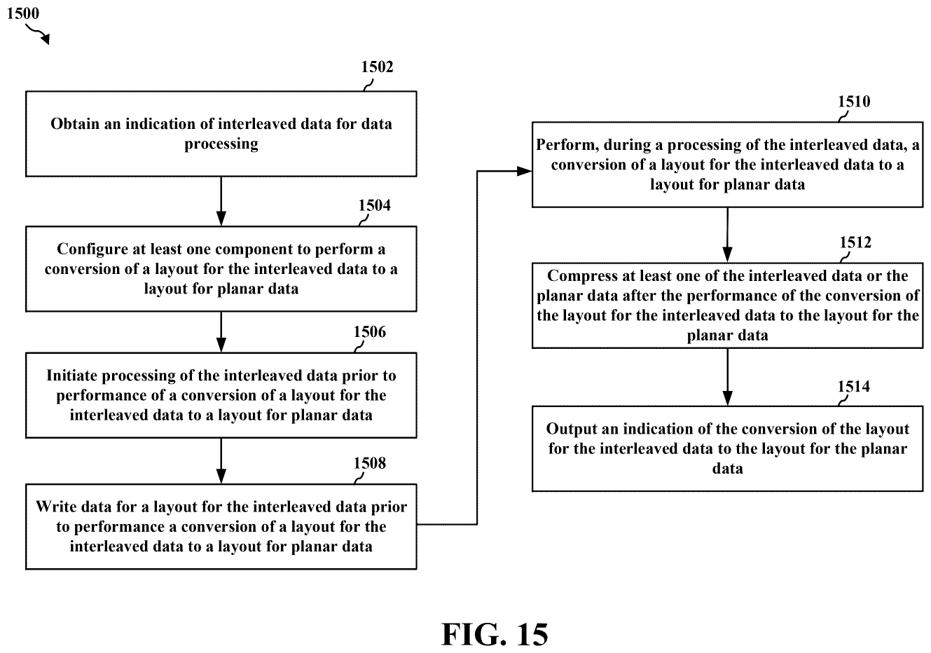

FIG. 15 is a flowchart 1500 of an example method of data processing in accordance with one or more techniques of this disclosure. The method may be performed by a GPU (e.g., a GPU, a graphics pipeline at a GPU, a shader processor at a GPU, a render backend (RB) in a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-13.

At 1502, the GPU may obtain an indication of interleaved data for the data processing, where the interleaved data corresponds to data in an interleaved format, as described in connection with the examples in FIGS. 1-13. For example, as described in 1310 of FIG. 13, GPU 1302 may obtain an indication of interleaved data for the data processing, where the interleaved data corresponds to data in an interleaved format. Further, step 1502 may be performed by processing unit 120 in FIG. 1. For example, GPU 1302 may obtain indication 1312 from application/GPU 1304.

At 1504, the GPU may configure at least one component to perform the conversion of the layout for the interleaved data to the layout for the planar data, as described in connection with the examples in FIGS. 1-13. For example, as described in 1320 of FIG. 13, GPU 1302 may configure at least one component to perform the conversion of the layout for the interleaved data to the layout for the planar data. Further, step 1504 may be performed by processing unit 120 in FIG. 1. In some aspects, the at least one component may be at least one graphics component in a graphics processing unit (GPU). Also, the at least one component in the GPU may be at least one of: a render backend (RB), a cache interfacing unit, or a controller for a compression engine or a decompression engine.

At 1506, the GPU may initiate the processing of the interleaved data prior to the performance of the conversion of the layout for the interleaved data to the layout for the planar data, as described in connection with the examples in FIGS. 1-13. For example, as described in 1330 of FIG. 13, GPU 1302 may initiate the processing of the interleaved data prior to the performance of the conversion of the layout for the interleaved data to the layout for the planar data. Further, step 1506 may be performed by processing unit 120 in FIG. 1. In some aspects, performing the conversion of the layout for the interleaved data to the layout for the planar data may comprise: performing, during at least one stage of the processing of the interleaved data, the conversion of the layout for the interleaved data to the layout for the planar data.

At 1508, the GPU may write data for the layout for the interleaved data prior to the performance the conversion of the layout for the interleaved data to the layout for planar data, as described in connection with the examples in FIGS. 1-13. For example, as described in 1340 of FIG. 13, GPU 1302 may write data for the layout for the interleaved data prior to the performance the conversion of the layout for the interleaved data to the layout for planar data. Further, step 1508 may be performed by processing unit 120 in FIG. 1. In some aspects, performing the conversion of the layout for the interleaved data to the layout for the planar data comprises: performing, based on writing the data, the conversion of the layout for the interleaved data to the layout for the planar data. Writing the data for the layout for the interleaved data may comprise: writing, to at least one of a color cache or a color memory, the data for the layout for the interleaved data, where the data in at least one of the color cache or the color memory is the planar data. Also, writing the data for the layout for the interleaved data may comprise: writing, to an interleaved color memory, the data for the layout for the interleaved data, where the data in the interleaved color memory is the interleaved data. Further, writing the data for the layout for the interleaved data may comprise: writing, to an interleaved color cache, the data for the layout for the interleaved data, where the data in the interleaved color cache is the interleaved data.

At 1510, the GPU may perform, during a processing of the interleaved data, a conversion of a layout for the interleaved data to a layout for planar data, where the planar data corresponds to the data in a planar format, as described in connection with the examples in FIGS. 1-13. For example, as described in 1350 of FIG. 13, GPU 1302 may perform, during a processing of the interleaved data, a conversion of a layout for the interleaved data to a layout for planar data, where the planar data corresponds to the data in a planar format. Further, step 1510 may be performed by processing unit 120 in FIG. 1. The layout for the interleaved data may be a memory layout for the interleaved data and the layout for the planar data may be a memory layout for the planar data. In some aspects, performing the conversion of the layout for the interleaved data to the layout for the planar data may comprise: organizing the memory layout for the interleaved data for the conversion to the memory layout for the planar data. Also, organizing the memory layout for the interleaved data may comprise: adjusting a block of interleaved pixels for the memory layout for the interleaved data. Further, adjusting the block of the interleaved pixels for the memory layout for the interleaved data may comprise: grouping at least one component of the block of the interleaved pixels to obtain at least one plane for an output for the planar data. Moreover, grouping the at least one component of the block of the interleaved pixels to obtain the at least one plane for the output for the planar data may comprise: grouping a first component and a second component of the block of the interleaved pixels to obtain a first plane and a second plane for the output for the planar data. The at least one component of the block of the interleaved pixels may be a set of four components of the block of the interleaved pixels, and the at least one plane for the output for the planar data may be a set of four planes for the output for the planar data.

At 1512, the GPU may compress at least one of the interleaved data or the planar data after the performance of the conversion of the layout for the interleaved data to the layout for the planar data, as described in connection with the examples in FIGS. 1-13. For example, as described in 1360 of FIG. 13, GPU 1302 may compress at least one of the interleaved data or the planar data after the performance of the conversion of the layout for the interleaved data to the layout for the planar data. Further, step 1512 may be performed by processing unit 120 in FIG. 1. In some aspects, compressing at least one of the interleaved data or the planar data may comprise: compressing, at an end of the processing of the interleaved data, at least one of the interleaved data or the planar data. The interleaved data may be data that includes a set of first pixel components that is a first threshold distance within one component of a pixel from the data, and the planar data may be data that includes a set of second pixel components that is a second threshold distance within one plane from the data. Additionally, the interleaved data may be at least one of: interleaved color data, interleaved pixel data, interleaved compute data, or interleaved graphics attributes, and the planar data may be at least one of: planar color data, planar pixel data, planar compute data, or planar graphics attributes.

At 1514, the GPU may output an indication of the conversion of the layout for the interleaved data to the layout for the planar data, as described in connection with the examples in FIGS. 1-13. For example, as described in 1370 of FIG. 13, GPU 1302 may output an indication of the conversion of the layout for the interleaved data to the layout for the planar data. Further, step 1514 may be performed by processing unit 120 in FIG. 1. In some aspects, outputting the indication of the conversion of the layout for the interleaved data to the layout for the planar data may comprise: transmitting the indication of the conversion of the layout for the interleaved data to the layout for the planar data. For example, GPU 1302 may transmit indication 1372 to application/GPU 1304. Further, outputting the indication of the conversion of the layout for the interleaved data to the layout for the planar data may comprise: storing, in a tile memory or a graphics memory, the indication of the conversion of the layout for the interleaved data to the layout for the planar data. For example, GPU 1302 may store indication 1374 in memory 1306.

In configurations, a method or an apparatus for data or graphics processing is provided. The apparatus may be a GPU (or other graphics processor), a CPU (or other central processor), a DDIC, an apparatus for data or graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining an indication of interleaved data for the data processing, where the interleaved data corresponds to data in an interleaved format. The apparatus, e.g., processing unit 120, may also include means for performing, during a processing of the interleaved data, a conversion of a layout for the interleaved data to a layout for planar data, where the planar data corresponds to the data in a planar format. The apparatus, e.g., processing unit 120, may also include means for outputting an indication of the conversion of the layout for the interleaved data to the layout for the planar data. The apparatus, e.g., processing unit 120, may also include means for writing data for the layout for the interleaved data prior to the performance the conversion of the layout for the interleaved data to the layout for planar data. The apparatus, e.g., processing unit 120, may also include means for compressing at least one of the interleaved data or the planar data after the performance of the conversion of the layout for the interleaved data to the layout for the planar data. The apparatus, e.g., processing unit 120, may also include means for initiating the processing of the interleaved data prior to the performance of the conversion of the layout for the interleaved data to the layout for the planar data. The apparatus, e.g., processing unit 120, may also include means for configuring at least one component to perform the conversion of the layout for the interleaved data to the layout for the planar data.

The subject matter described herein may be implemented to realize one or more benefits or advantages. For instance, the described data or graphics processing techniques may be used by a GPU, a shader processor, a render backend, a CPU, a central processor, or some other processor that may perform data or graphics processing to implement the conversion techniques described herein. This may also be accomplished at a low cost compared to other data or graphics processing techniques. Moreover, the data or graphics processing techniques herein may improve or speed up data processing or execution. Further, the data or graphics processing techniques herein may improve resource or data utilization and/or resource efficiency. Additionally, aspects of the present disclosure may utilize conversion techniques in order to improve memory bandwidth efficiency and/or increase processing speed at a GPU, a shader processor, a CPU, or a display processing unit (DPU).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for data processing, including at least one memory; and at least one processor coupled to the at least one memory and, based at least in part on information stored in the at least one memory, the at least one processor is configured to: obtain an indication of interleaved data for the data processing, wherein the interleaved data corresponds to data in an interleaved format; perform, during a processing of the interleaved data, a conversion of a layout for the interleaved data to a layout for planar data, wherein the planar data corresponds to the data in a planar format; and output an indication of the conversion of the layout for the interleaved data to the layout for the planar data.

Aspect 2 is the apparatus of aspect 1, wherein the at least one processor is further configured to: write data for the layout for the interleaved data prior to the performance the conversion of the layout for the interleaved data to the layout for planar data, wherein to perform the conversion of the layout for the interleaved data to the layout for the planar data, the at least one processor is configured to: perform, based on writing the data, the conversion of the layout for the interleaved data to the layout for the planar data.

Aspect 3 is the apparatus of aspect 2, wherein to write the data for the layout for the interleaved data, the at least one processor is configured to: write, to at least one of a color cache or a color memory, the data for the layout for the interleaved data, wherein the data in at least one of the color cache or the color memory is the planar data.

Aspect 4 is the apparatus of any of aspects 2 to 3, wherein to write the data for the layout for the interleaved data, the at least one processor is configured to: write, to an interleaved color memory, the data for the layout for the interleaved data, wherein the data in the interleaved color memory is the interleaved data.

Aspect 5 is the apparatus of any of aspects 2 to 4, wherein to write the data for the layout for the interleaved data, the at least one processor is configured to: write, to an interleaved color cache, the data for the layout for the interleaved data, wherein the data in the interleaved color cache is the interleaved data.

Aspect 6 is the apparatus of any of aspects 1 to 5, wherein the layout for the interleaved data is a memory layout for the interleaved data and the layout for the planar data is a memory layout for the planar data, and wherein to perform the conversion of the layout for the interleaved data to the layout for the planar data, the at least one processor is configured to: organize the memory layout for the interleaved data for the conversion to the memory layout for the planar data.

Aspect 7 is the apparatus of aspect 6, wherein to organize the memory layout for the interleaved data, the at least one processor is configured to: adjust a block of interleaved pixels for the memory layout for the interleaved data.

Aspect 8 is the apparatus of aspect 7, wherein to adjust the block of the interleaved pixels for the memory layout for the interleaved data, the at least one processor is configured to: group at least one component of the block of the interleaved pixels to obtain at least one plane for an output for the planar data.

Aspect 9 is the apparatus of aspect 8, wherein group the at least one component of the block of the interleaved pixels to obtain the at least one plane for the output for the planar data, the at least one processor is configured to: group a first component and a second component of the block of the interleaved pixels to obtain a first plane and a second plane for the output for the planar data.

Aspect 10 is the apparatus of any of aspects 8 to 9, wherein the at least one component of the block of the interleaved pixels is a set of four components of the block of the interleaved pixels, and wherein the at least one plane for the output for the planar data is a set of four planes for the output for the planar data.

Aspect 11 is the apparatus of any of aspects 1 to 10, wherein the at least one processor is further configured to: compress at least one of the interleaved data or the planar data after the performance of the conversion of the layout for the interleaved data to the layout for the planar data.

Aspect 12 is the apparatus of aspect 11, wherein to compress at least one of the interleaved data or the planar data, the at least one processor is configured to: compress, at an end of the processing of the interleaved data, at least one of the interleaved data or the planar data.

Aspect 13 is the apparatus of any of aspects 1 to 12, wherein the at least one processor is further configured to: initiate the processing of the interleaved data prior to the performance of the conversion of the layout for the interleaved data to the layout for the planar data.

Aspect 14 is the apparatus of aspect 13, wherein to perform the conversion of the layout for the interleaved data to the layout for the planar data, the at least one processor is configured to: perform, during at least one stage of the processing of the interleaved data, the conversion of the layout for the interleaved data to the layout for the planar data.

Aspect 15 is the apparatus of any of aspects 1 to 14, wherein the at least one processor is further configured to: configure at least one component to perform the conversion of the layout for the interleaved data to the layout for the planar data.

Aspect 16 is the apparatus of aspect 15, wherein the at least one component is at least one graphics component in a graphics processing unit (GPU).

Aspect 17 is the apparatus of aspect 16, wherein the at least one component in the GPU is at least one of: a render backend (RB), a cache interfacing unit, or a controller for a compression engine or a decompression engine.

Aspect 18 is the apparatus of any of aspects 1 to 17, wherein the interleaved data is data that includes a set of first pixel components that is a first threshold distance within one component of a pixel from the data, and wherein the planar data is data that includes a set of second pixel components that is a second threshold distance within one plane from the data.

Aspect 19 is the apparatus of any of aspects 1 to 18, wherein the interleaved data is at least one of: interleaved color data, interleaved pixel data, interleaved compute data, or interleaved graphics attributes, and wherein the planar data is at least one of: planar color data, planar pixel data, planar compute data, or planar graphics attributes.

Aspect 20 is the apparatus of any of aspects 1 to 19, wherein to output the indication of the conversion of the layout for the interleaved data to the layout for the planar data, the at least one processor is configured to: transmit the indication of the conversion of the layout for the interleaved data to the layout for the planar data; or store the indication of the conversion of the layout for the interleaved data to the layout for the planar data.

Aspect 21 is the apparatus of aspect 20, wherein the apparatus is a wireless communication device, further including (i.e., comprising) at least one of an antenna or a transceiver coupled to the at least one processor, wherein to transmit the indication of the conversion of the layout for the interleaved data to the layout for the planar data, the at least one processor is configured to: transmit, via at least one of the antenna or the transceiver, the indication of the conversion of the layout for the interleaved data to the layout for the planar data.

Aspect 22 is a method of data processing for implementing any of aspects 1 to 21.

Aspect 23 is an apparatus for data processing including means for implementing any of aspects 1 to 21.

Aspect 24 is a computer-readable medium (e.g., a non-transitory computer-readable medium) storing computer executable code (e.g., code for data processing), the code when executed by a processor causes the processor to implement any of aspects 1 to 21.

What is claimed is:

1. An apparatus for data processing, comprising:
at least one memory; and
at least one processor coupled to the at least one memory and, based at least in part on information stored in the at least one memory, the at least one processor is configured to:
obtain an indication of interleaved data for the data processing, wherein the interleaved data corresponds to data in an interleaved format;
perform, during a processing of the interleaved data, a conversion of a layout for the interleaved data to a layout for planar data, wherein the planar data corresponds to the data in a planar format; and
output an indication of the conversion of the layout for the interleaved data to the layout for the planar data.

2. The apparatus of claim 1, wherein the at least one processor is further configured to:
write data for the layout for the interleaved data prior to the performance the conversion of the layout for the interleaved data to the layout for the planar data, wherein to perform the conversion of the layout for the interleaved data to the layout for the planar data, the at least one processor is configured to: perform, based on writing the data, the conversion of the layout for the interleaved data to the layout for the planar data.

3. The apparatus of claim 2, wherein to write the data for the layout for the interleaved data, the at least one processor is configured to:
write, to at least one of a color cache or a color memory, the data for the layout for the interleaved data, wherein the data in at least one of the color cache or the color memory is the planar data.

4. The apparatus of claim 2, wherein to write the data for the layout for the interleaved data, the at least one processor is configured to:
write, to an interleaved color memory, the data for the layout for the interleaved data, wherein the data in the interleaved color memory is the interleaved data.

5. The apparatus of claim 2, wherein to write the data for the layout for the interleaved data, the at least one processor is configured to:
write, to an interleaved color cache, the data for the layout for the interleaved data, wherein the data in the interleaved color cache is the interleaved data.

6. The apparatus of claim 1, wherein the layout for the interleaved data is a memory layout for the interleaved data and the layout for the planar data is a memory layout for the planar data, and wherein to perform the conversion of the layout for the interleaved data to the layout for the planar data, the at least one processor is configured to:
organize the memory layout for the interleaved data for the conversion to the memory layout for the planar data.

7. The apparatus of claim 6, wherein to organize the memory layout for the interleaved data, the at least one processor is configured to:
adjust a block of interleaved pixels for the memory layout for the interleaved data.

8. The apparatus of claim 7, wherein to adjust the block of the interleaved pixels for the memory layout for the interleaved data, the at least one processor is configured to:
group at least one component of the block of the interleaved pixels to obtain at least one plane for an output for the planar data.

9. The apparatus of claim 8, wherein group the at least one component of the block of the interleaved pixels to obtain the at least one plane for the output for the planar data, the at least one processor is configured to:
group a first component and a second component of the block of the interleaved pixels to obtain a first plane and a second plane for the output for the planar data.

10. The apparatus of claim 8, wherein the at least one component of the block of the interleaved pixels is a set of four components of the block of the interleaved pixels, and wherein the at least one plane for the output for the planar data is a set of four planes for the output for the planar data.

11. The apparatus of claim 1, wherein the at least one processor is further configured to:
compress at least one of the interleaved data or the planar data after the performance of the conversion of the layout for the interleaved data to the layout for the planar data.

12. The apparatus of claim 11, wherein to compress at least one of the interleaved data or the planar data, the at least one processor is configured to:
compress, at an end of the processing of the interleaved data, at least one of the interleaved data or the planar data.

13. The apparatus of claim 1, wherein the at least one processor is further configured to:
initiate the processing of the interleaved data prior to the performance of the conversion of the layout for the interleaved data to the layout for the planar data.

14. The apparatus of claim 13, wherein to perform the conversion of the layout for the interleaved data to the layout for the planar data, the at least one processor is configured to:
perform, during at least one stage of the processing of the interleaved data, the conversion of the layout for the interleaved data to the layout for the planar data.

15. The apparatus of claim 1, wherein the at least one processor is further configured to:
configure at least one component to perform the conversion of the layout for the interleaved data to the layout for the planar data.

16. The apparatus of claim 15, wherein the at least one component is at least one graphics component in a graphics processing unit (GPU), wherein the at least one component in the GPU is at least one of: a render backend (RB), a cache interfacing unit, or a controller for a compression engine or a decompression engine.

17. The apparatus of claim 1, wherein the interleaved data is data that includes a set of first pixel components that is a first threshold distance within one component of a pixel from the data, and wherein the planar data is data that includes a set of second pixel components that is a second threshold distance within one plane from the data.

18. The apparatus of claim 1, wherein the interleaved data is at least one of: interleaved color data, interleaved pixel data, interleaved compute data, or interleaved graphics attributes, and wherein the planar data is at least one of: planar color data, planar pixel data, planar compute data, or planar graphics attributes.

19. A method of data processing, comprising:
obtaining an indication of interleaved data for the data processing, wherein the interleaved data corresponds to data in an interleaved format;
performing, during a processing of the interleaved data, a conversion of a layout for the interleaved data to a layout for planar data, wherein the planar data corresponds to the data in a planar format; and
outputting an indication of the conversion of the layout for the interleaved data to the layout for the planar data.

20. A computer-readable medium storing computer executable code for data processing, the code when executed by at least one processor causes the at least one processor to:
obtain an indication of interleaved data for the data processing, wherein the interleaved data corresponds to data in an interleaved format;
perform, during a processing of the interleaved data, a conversion of a layout for the interleaved data to a layout for planar data, wherein the planar data corresponds to the data in a planar format; and
output an indication of the conversion of the layout for the interleaved data to the layout for the planar data.
